(19) United States
(12) Patent Application Publication
(10) Pub. No.: US 2003/0234122 A1
(43) Pub. Date: Dec. 25, 2003

(54) Fork tine scale technology

(76) Inventors: William P. Kroll, Hamel, MN (US); Randie Evenson, Brooklyn Center, MN (US)

Correspondence Address: JOEL D. SKINNER, JR., SKINNER AND ASSOCIATES, 212 COMMERCIAL ST., HUDSON, WI, 54016, US

(21) Appl. No.: 10/177,586

(22) Filed: Jun. 19, 2002

(51) Int. Cl. G01G 19/02; G01G 19/52

(52) U.S. Cl. 177/146

(57) ABSTRACT

A tine mounted weighing scale apparatus includes a pair of weighing scale units, each scale unit having a base mountable on one tine of a lifting device. The base has a predetermined number of load cell mounts each providing a deflection gap between a load cell and the base. A platform for contact with a load is disposed above and in operational contact with the base. A load cell is attached to each of the load cell mounts of the base and is positioned between the base and the platform. Each load cell has an engagement member in operational contact with the platform. An electrical control/display and a power supply is connected to the pair of weighing scale units for displaying the total weight supported by the scale apparatus.

### CROSS-REFERENCE TO RELATED APPLICATIONS, IF ANY

This application claims the benefit under 35 U.S.C. §119(e) of copending provisional application Serial No. 60/299,127, filed Jun. 18, 2001, which is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to weighing apparatus. More particularly, the invention relates to portable, low profile weighing scales. Most particularly, the invention relates to a weighing scale system for use with a lifting device. The weighing scale provided by this invention is useful for efficiently, reliably and accurately weighing articles having a large and/or irregular support base.

2. Background Information.

Applicants Kroll et al. discloses scales in U.S. Pat. Nos. 4,714,121, 4,979,581, 5,232,064, 5,646,376, and 5,894,112, and load cells in U.S. Pat. Nos. 4,775,018, 4,813,504, and 5,228,527. The scales and load cells handle abroad range of capacities and have varying degrees of accuracy. Additionally, the scales have varied designs in terms of height, weight, portability and method of use. A common design factor shared by all of these scales and load cells is that in each, the mounting of the load cell in and to the scale is unique and provides a significant advantage over the prior art.

Wheel scales or platform scales are commonly used to measure axle weight loads of vehicles and aircraft. These scales are designed to be used singly, or multiply in concert, with the vehicle rolled onto the scale(s) and the weight of the vehicle thus determined with the wheels resting on the scale(s). However, these small footprint scales are not ideally suited for articles having a large and/or irregular support base that contacts the surface on which the articles rests.

Scales with large weighing platforms are known, but their size renders the scale immobile. Thus, the large/irregular support base article must be moved onto and off the platform for weighing, or articles to be weighed must be moved to a permanently placed scale, which may be a long distance away. Fork lift truck scales and pallet truck scales are available for weighing articles elevated on the tines of these lifting devices. The weighing scale is interposed between the tines and the lifting mechanism of the lifting device, resulting in a complex arrangement.

Thus, there is an unmet need for a weighing scale that can be fitted to a lifting device, transported to such large/irregular support base articles, and obtain the article weight efficiently, reliably and accurately, without excessive movement of the article. The invention provides a weighing scale system, which is believed to fulfill the need and to constitute an improvement over the background technology.

All U.S. patents and patent applications, and all other published documents mentioned anywhere in this application are incorporated by reference in their entirety.

### BRIEF SUMMARY OF THE INVENTION

The present invention provides an apparatus and method for weighing articles that can be elevated by a lifting device. In one embodiment, the apparatus includes a weighing scale comprising a base mountable on a tine of a lifting device, the base having a predetermined number of load cell mounts, each one of the load cell mounts providing a deflection gap between the load cell and the base. A platform for contact with a load is disposed above and in operational contact with the base. A number of load cells equal to the number of load cell mounts is present, with each one of the load cells attached to one of the load cell mounts of the base and positioned between the base and the platform. A number of engagement members equal to the number of load cells are present, with each one of the engagement members in operational contact with the platform and one of the load cells.

In another embodiment, the apparatus includes a tine mounted weighing scale apparatus comprising a pair of weighing scale units, each unit mountable to one tine of a lifting device. Each weighing scale unit includes a base mountable on a tine of a lifting device, the base having a predetermined number of load cell mounts, each one of the load cell mounts providing a deflection gap between the load cell and the base. A platform for contact with a load is disposed above and in operational contact with the base. A number of load cells equal to the number of load cell mounts is present, with each one of the load cells being attached to one of the load cell mounts of the base and positioned between the base and the platform. A number of engagement members equal to the number of load cells are present, with each one of the engagement members being in operational contact with the platform and one of the load cells. An electrical control/display and a power supply are operatively connected to the pair of weighing scale units for displaying the total weight supported by the scale apparatus.

In another embodiment, the apparatus includes a tine mounted weighing scale apparatus comprising a pair of weighing scale units, each unit mountable to one tine of a lifting device. Each weighing scale unit includes a base mountable on a tine of a lifting device, the base having a predetermined number of load cell mounts, each one of the load cell mounts providing a deflection gap between the load cell and the base. The base includes a sheath adapted for receiving a tine of a lifting device and a fastener for securing the sheath-containing base to the tine of the lifting device. A platform for contact with a load is disposed above and in operational contact with the base. A number of shear beam load cells equal to the number of load cell mounts is present, with each one of the shear beam load cells attached to one of the load cell mounts of the base and positioned between the base and the platform. A number of engagement members equal to the number of shear beam load cells is present, with each one of the engagement members in operational contact with the platform and one of the shear beam load cells. The engagement members include a fork nut secured to a bottom surface of the platform, the fork nut having a threaded cavity therein, and a threaded fastener traversing the load cell and secured within the nut threaded cavity. A summing box for summing output from the predetermined number of shear beam load cells is present. An electrical control/display and a power supply are operatively connected in series to the pair of weighing scale units for displaying the total weight supported by the scale apparatus.

In another embodiment, the method of weighing an article with a lifting device includes the steps of providing a tine mounted weighing scale apparatus having a pair of weighing scale units, each unit mountable to one tine of the lifting device. Each weighing scale unit includes a base mountable on a tine of a lifting device, the base having a predetermined number of load cell mounts, each one of the load cell mounts providing a deflection gap between the load cell and the base. A platform for contact with a load is disposed above and in operational contact with the base. A number of load cells equal to the number of load cell mounts are present, with each one of the load cells attached to one of the load cell mounts of the base and positioned between the base and the platform. A number of engagement members equal to the number of load cells are present, with each one of the engagement members in operational contact with the platform and one of the load cells. An electrical control/display and a power supply are operatively connected to the pair of weighing scale units for displaying the total weight supported by the scale apparatus.

Each scale unit of the weighing scale apparatus is secured to the tine of a lifting device. The article is elevated off a support surface using the lifting device fitted with the scale apparatus, and the weight determined by observing the output of the electrical display.

The features, benefits and objects of the invention will become clear to those skilled in the art by reference to the following description, claims and drawings.

### BRIEF DESCRIPTION OF THE SEVERAL VIEWS OF THE DRAWING

FIG. 1 is a top view of a weighing scale of the present invention.

FIG. 2 is a front view of the display screen of the control/display of the present invention.

FIG. 3 is a top view of the control/display unit of the present invention.

FIG. 4 is an exploded perspective view of one scale unit of the present invention.

FIG. 5 is a perspective view of the base member of the scale unit.

FIG. 6 is a perspective view of the base plate portion of the base member.

FIG. 7 is a bottom perspective view of the base top plate portion of the base member.

FIG. 8 is a perspective view of the platform member bottom of the scale unit.

FIG. 9 is a cross sectional view of one of the load cells secured between the base member and the platform member.

FIG. 10 is an exploded perspective view of another embodiment of one scale unit of the present invention.

FIG. 11 is a perspective view of the platform member bottom of the embodiment of FIG. 10.

FIG. 12 is a cross sectional view of one of the load cells secured between the base member and the platform member of the embodiment of FIG. 10.

### DETAILED DESCRIPTION

The present invention is a weighing scale apparatus that is useful for weighing articles having a large and/or irregular support base, such as one or more items loaded on a pallet. Other such articles include containers, large footprint machinery, vehicles and various hard to move items. The weighing scale assembly is secured to the tines of a fork lift truck or pallet truck, and provides weighing of articles, such as a loaded pallet, by elevation of the article off the support surface by the weighing scale apparatus/tine lifting device.

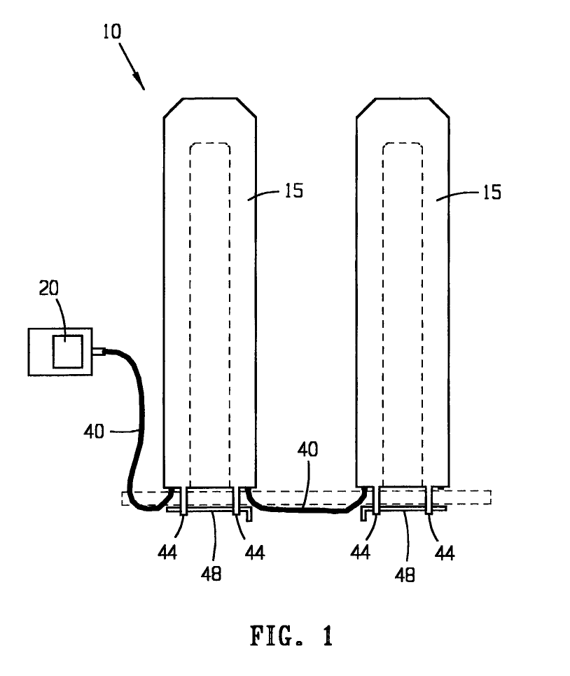

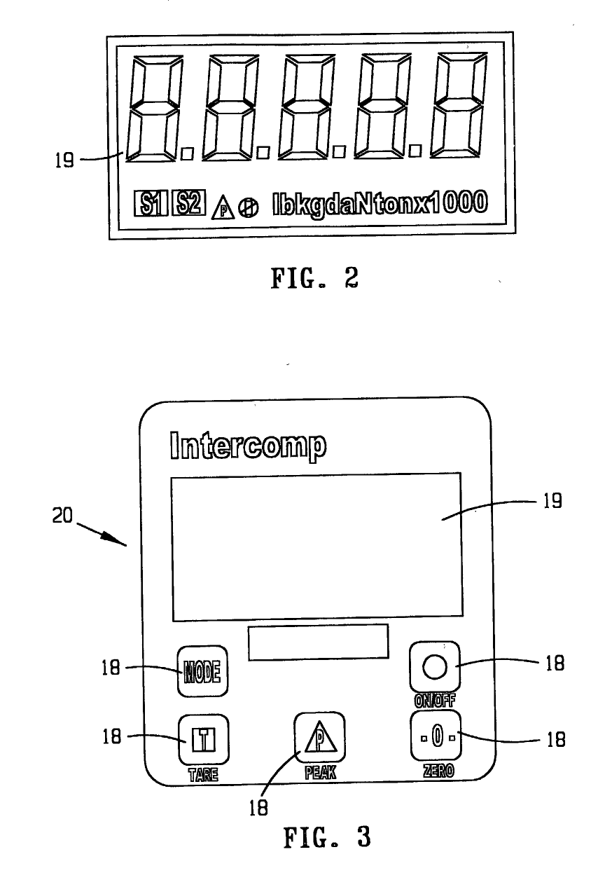

FIG. 1 show one embodiment of the present invention, illustrated and generally indicated by the reference numeral 10. Referring to FIG. 1, the tine mounted weighing scale apparatus 10 includes a pair of weighing scale units 15, each mounted on one tine (shown in phantom) of a lifting device, such as a fork lift truck or pallet truck. Each scale unit 15 includes a fastener for securing the scale unit 15 to the tine, such as fastener straps 44 and a locking bar member 48, as illustrated in FIG. 1. The scale units 15 are connected in series to an electronic control and display unit 20 remote from the scale units 15. The power unit for the apparatus is preferably one or more batteries, with the power unit preferably contained within the control/display unit 20. An enlarged top view of the face of the control/display unit 20 is shown in FIG. 3, the face including a number of control buttons 18 and a display screen 19 illustrated in greater detail in FIG. 2. The weighing scale apparatus 10 is readily mounted to or removed from a tined lifting device, such as a fork truck or a pallet truck. The flexible conductor wires 40 between each scale unit 15 and from one scale unit 15 and to the control and display unit 20 provides facile mounting of the weighing scale assembly 10 to various sized and configured tined lifting devices.

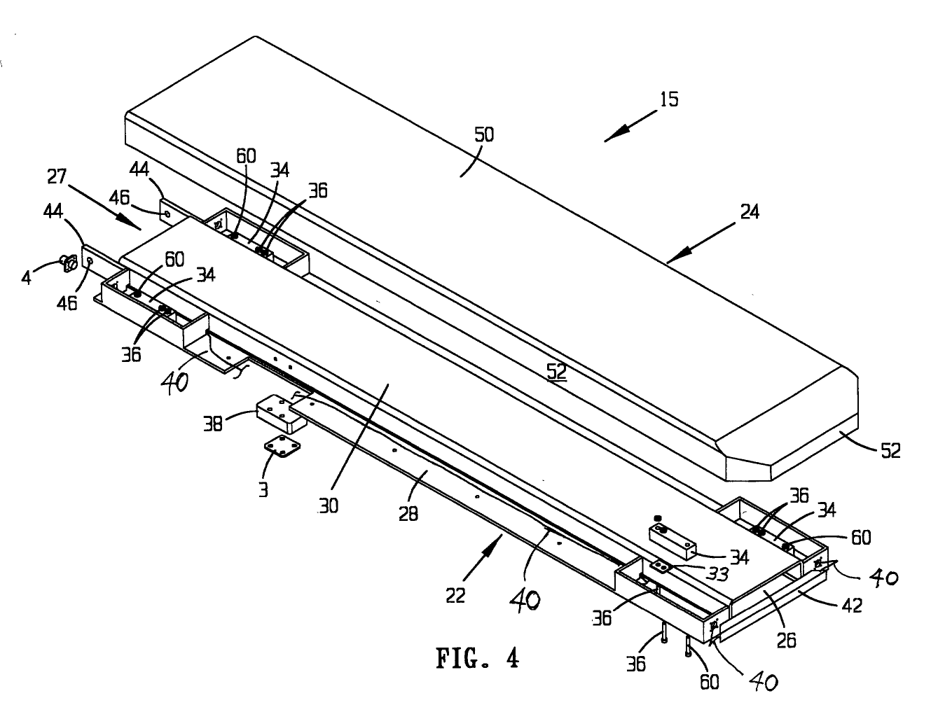

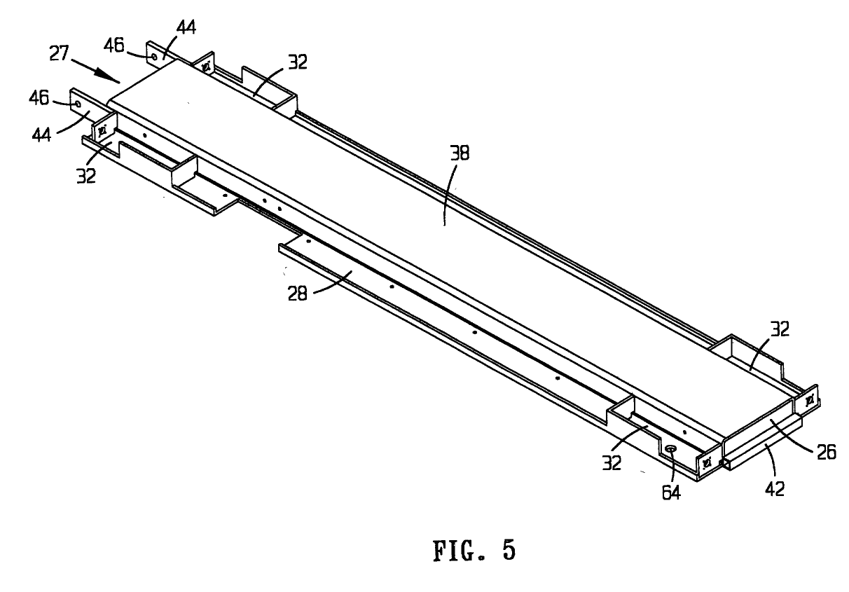

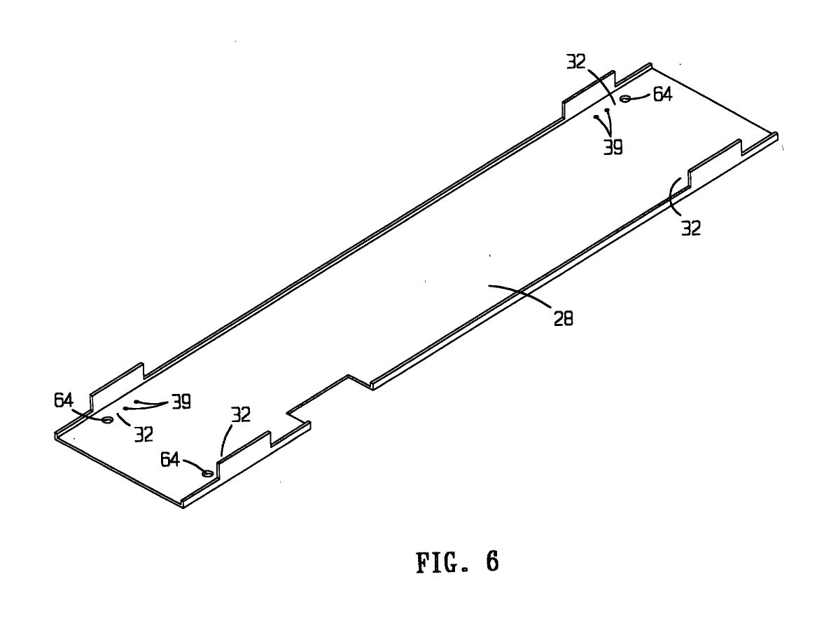

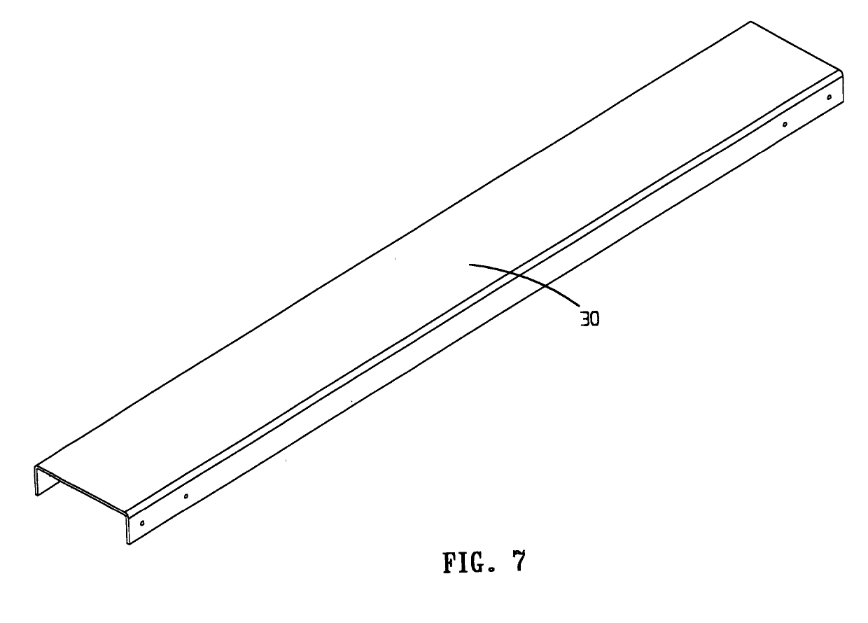

Referring now to FIG. 4, one of the weighing scale units 15 is shown in a perspective, exploded view. The weighting scale unit 15 includes a base member 22 and a platform member 24 secured in register to the base member 22, the scale unit 15 designed for accepting a tine of the lifting device. The base member 22 has an interior, sheath-like longitudinal cavity 26 therein with an open end 27 into which the tine is reversibly positioned. The base member 22, shown in greater detail in FIGS. 5-7, is composed of a planar base plate portion 28 (FIG. 6) and a U-shaped base top plate portion 30 (FIG. 7). When secured together, the two portions 28, 30 form the sheath-like cavity 26 that accepts the lifting device tine. The base plate portion 28 is the same length, but wider than the top plate portion 30, thereby providing areas exterior the sheath-like cavity 26 for locating a plurality of load cell mounts 32, each for mounting a load cell 34 thereto. In the present embodiment, there are four load cell mounts 32 and four associated load cells 34, with one mount 32 and associated load cell 34 disposed at each corner of the base plate portion 28 of the base member 24. A greater number of load cell mounts 32 and associated load cells 34 may be included in the present invention with equivalent results. The load cells 34 are preferably shear beam load cells 34, described in detail below. Each rectangular load cell 34 is secured at one end to the load cell mount 32 by a pair of threaded fasteners 36 extending from beneath the base member 24 and through the load cell 34 to engage threaded nuts 36′. The load cells 34 engage and vertically support the platform member 24 via engagement members 37, also described in detail below. Other load cell mount configurations are anticipated. However, the present load cell mount configuration is preferable for the type of load cells being used in this invention.

The load cells 34 are operatively connected to a summing box 38, also secured to the base plate portion, by conductor wires 40 that are routed exterior the sheath-like cavity 26. The conductor wires 40 are routed through an end tube member 42 from one side of the scale unit 15 to the other. The summing box 38 of each scale unit 15 is connected in series to the electronic control and display member 20, as illustrated in FIG. 1. Fastener strips 44 are secured to the base member 22 adjacent the open end 27 of the sheath-like cavity 26 for attaching the scale unit 15 to the lifting device tine. The fastener strips 44 each include an aperture 46 that accepts a locking bar 48 for securing the scale member 15 to the tine, as illustrated in FIG. 1. Alternatively, the apertures 46 may be threaded to accept a set screw (not shown) that engages the tine to secure the scale member 15 thereto.

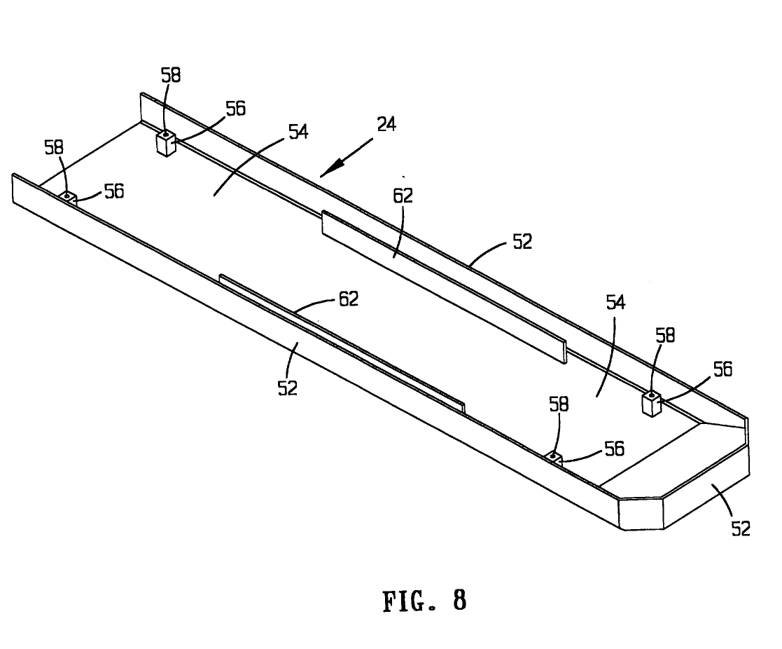

The platform member 24 includes a top contact surface 50 and downward extending perimeter walls 52 on one end and two sides, with no wall adjacent the sheath-cavity open end 27. The platform member 24 is sized to cover the top and sides of the base member 22, thereby covering and protecting the load cells 34, summing box 38 and associated conductor wires 40. The bottom surface 54 of the platform member 24 is shown in FIG. 8 where a plurality, in this case four, of fork nuts 56 is secured thereto. Each fork nut 56 is positioned on the platform member bottom surface 54 such that a threaded cavity 58 therein is in register with a load cell 34 on the base member 22.

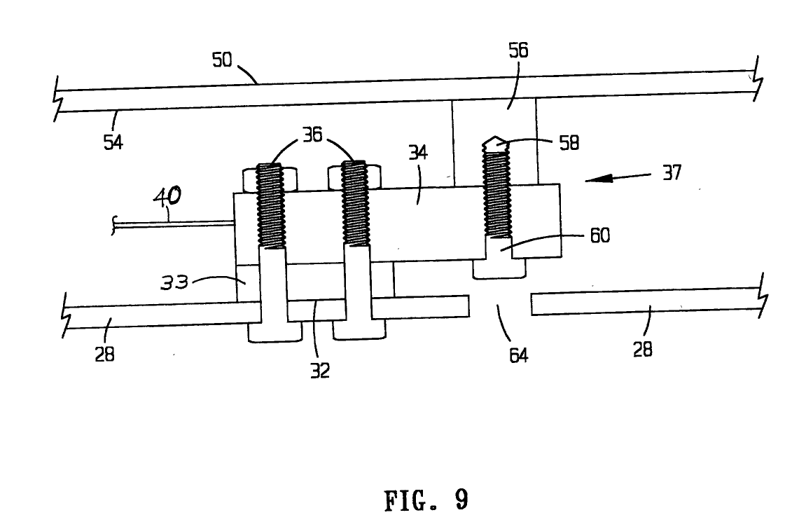

Referring now to FIG. 9, the load cell mount 32, load cell 34 and engagement means 37 are shown in cross section. The load cell 34 has an elongated, generally square cross sectional configuration. A pair of mounting apertures 35 is located proximate one end of the load cell 34. The apertures 35 permit the load cell 34 to be mounted to the load cell mount 32 of the base plate portion 28 by the mounting bolts 36 positioned in the base mounting apertures 39 of the base member 24. A spacer 33, smaller than the load cell 34, is positioned between the load cell mount 32 and the load cell 34, adjacent the load cell mounting apertures 35. The spacer 33 elevates the shear beam load cell 34, thereby extending the load cell 34 above the base plate portion 28 at an end opposite the threaded fasteners 36 securing the load cell 34 thereto. A threaded fastener 60, passing through a third load cell aperture 62, secures the load cell 34 at the elevated end to one fork nut 56 of the platform member 24, as illustrated in FIG. 9. Thus, the fork nut 56 and the threaded fastener 60 comprise the engagement means 37 between the load cell 34 and the platform member 24. The base plate portion 28 also contains an access aperture 64 for accessing the threaded fastener 60, allowing the plate member 24 to be secured to or removed from the base member 22. The plate member bottom surface 54 also contains a pair of linear supports 66 to provide added stability between the base member 22 and the platform member 24. Thus, a load placed on the platform member 24 causes a deflection of the load cell 34 at the end opposite the threaded fasteners 36 securing the load cell 34 to the base plate portion 28. A cable connection 41 is disposed at the end of the load cell 34 to receive an electrical conductor wire 40. The conductor wire 40 provides electrical communication between the load cell 34 and the summing box 38. Strain gauges (not shown) are disposed within the load cell 34 to measure dimensional changes in the load cell 34 caused by the load. The operation of a strain gauge is based on the principle that the electrical resistance of a conductor changes when it is subjected to a mechanical deformation. There are a number of resistance strain gauge types that may be used, including bonded strain gauge, wire gauge, foil gauge and semiconductor gauge. As each strain gauge is mechanically deformed, its length and diameter are altered, resulting in a change in its electrical resistance, which is used to calculate a weight.

The proper orientation of the strain gauges on each mounted and aligned load cell 34 permits accurate weighing irrespective of the exact location of the load relative to the contact surface 50 of the platform member 24 that may be due to uneven load placement or tilting of each weighing scale unit 15. The design of the platform members 24, engagement means 37, load cells 34 and base members 22 cooperate to permit the proper deflection of the load cell 34 for accurate and repeatable readings without the potentially damaging side load effects and torquing.

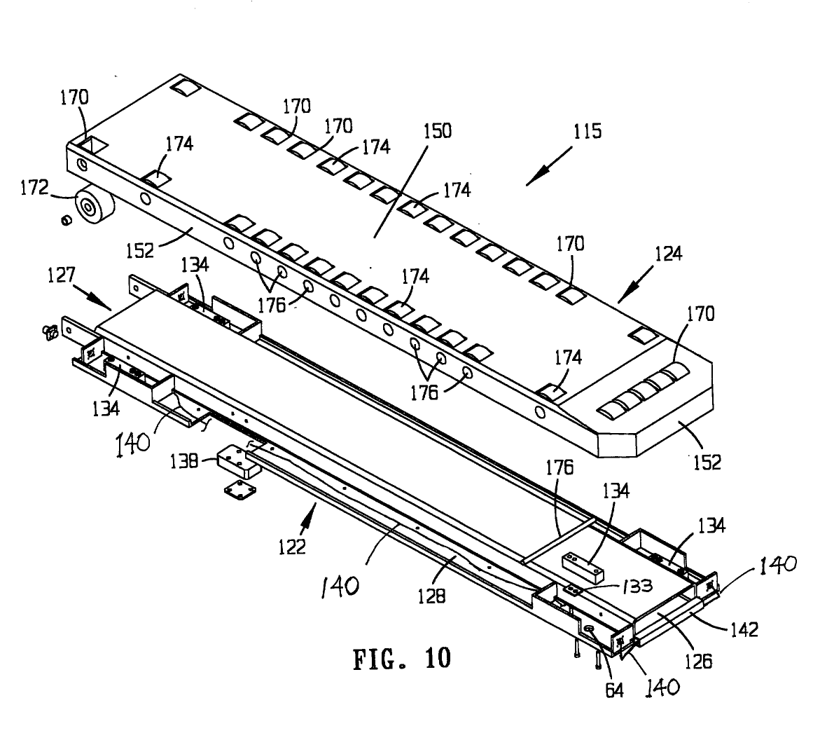

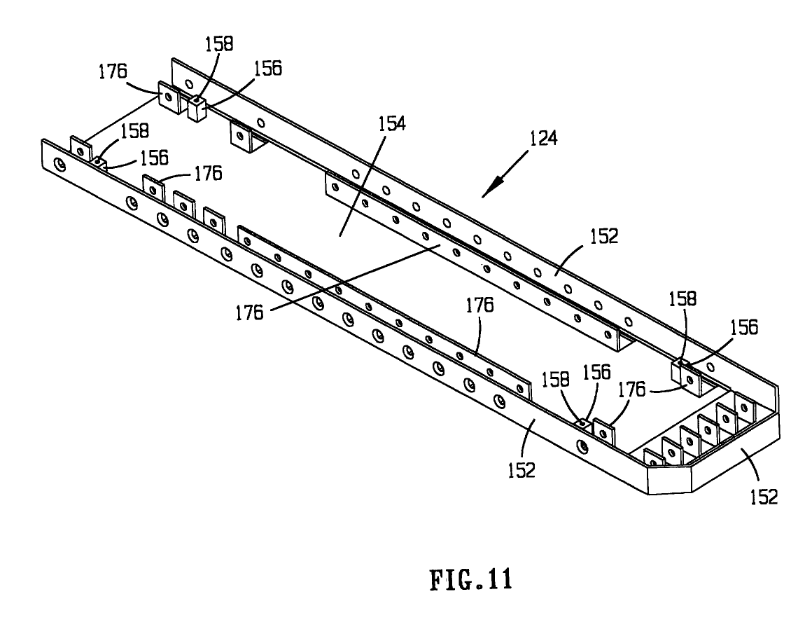

Another embodiment of the tine mounted weighing scale apparatus 110 is shown in FIGS. 10 and 11. The scale apparatus 110 again includes a pair of weighing scale units 115, each mounted on one tine (shown in phantom) of a lifting device, such as a fork lift truck or pallet truck. Each scale unit 115 includes a means for securing the scale unit 115 to the tine, such as fastener straps 144 and a locking bar member 148, as illustrated in FIG. 1. The scale units 115 are connected in series to an electronic control and display unit 120 remote from the scale units 115. The weighing scale apparatus 110 is readily mounted to or removed from a tined lifting device, such as a fork truck or a pallet truck. The flexible conductor wires 140 between each scale unit 115, and from one scale unit 115 to the control and display unit 120, provides facile mounting of the weighing scale assembly 110 to various sized and configured tined lifting devices.

Referring now to FIG. 10, one of the weighing scale units 115 is shown in an exploded view. The weighting scale unit 115 includes a base member 122 and a platform member 124 secured in register to the base member 122, the scale unit 115 designed for accepting a tine of the lifting device. The base member 122 has an interior, sheath-like longitudinal cavity 126 therein with an open end 127 into which the tine is reversibly positioned. The base member 122 is composed of a planar base plate portion 128 and a U-shaped base top plate portion 130 that form the sheath-like cavity 126 that accepts the lifting device tine, and is essentially identical to base member 22 described in detail above. There are four load cell mounts 132 and four load cells 134 disposed at each corner of the base portion 128 of the base member 124 as described in detail above.

The platform member 124 includes a top contact surface 150 and downward extending perimeter walls 152 on one end and two sides with no wall adjacent the sheath-cavity open end 127. The platform member 124 is sized to cover the top and sides of the base member 122, thereby covering and protecting the load cells 134, summing box 138 and associated conductor wires 140. The bottom surface 154 of the platform member 124 is shown in FIG. 11 where a plurality, in this case four, of fork nuts 156 is secured thereto. Each fork nut 156 is positioned on the platform member bottom surface 154 such that a threaded cavity 158 therein is in register with a load cell 134 on the base member 122.

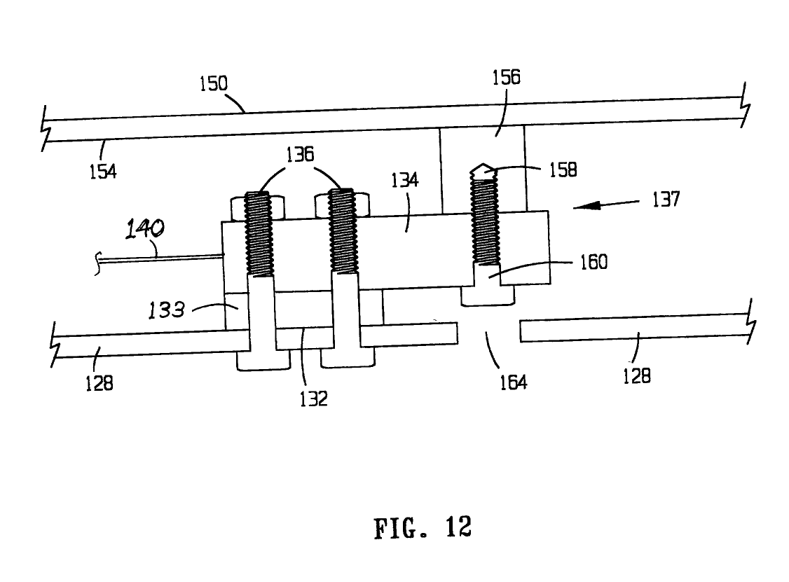

Referring now to FIG. 12, the load cell mount 132, load cell 134 and engagement means 137 are shown in cross section. The load cell 134 has an elongated, generally square cross sectional configuration. A pair of mounting apertures 135 is located proximate one end of the load cell 134. The apertures 135 permit the load cell 134 to be mounted to the load cell mount 132 of the base plate portion 128 by the mounting bolts 136 positioned in the base mounting apertures 139 of the base member 124. A spacer 133, smaller than the load cell 134, is positioned between the load cell mount 132 and the load cell 134 adjacent the load cell mounting apertures 135. The spacer 133 elevates the shear beam load cell 134, thereby extending the load cell 134 above the base plate portion 128 at an end opposite the threaded fasteners 136 securing the load cell 134 thereto. A threaded fastener 160, passing through a third load cell aperture 162, secures the load cell 134 at the elevated end to the fork nut 156 of the platform member 126, as illustrated in FIG. 12. Thus, the fork nut 156 and the threaded fastener 160 comprise the engagement means 137 between the load cell 134 and the platform member 124. The base plate portion 128 also contains an access aperture 164 for accessing the threaded fastener 160, allowing the plate member 124 to be secured to or removed from the base member 122. Thus, a load placed on the platform member 124 causes a deflection of the load cell 134 at the end opposite the threaded fasteners 136 securing the load cell 134 to the base plate portion 128.

The platform member 124 also includes a plurality of slot apertures 170, located around the periphery of the flat, top contact surface 150. Within each slot aperture 170 is mounted a roller member 172 such that the roller circumference surface 174 extends slightly above the platform surface 150, and with the rotational axes of the roller members 172 in parallel. The roller members 172 are mounted on pins or axles 176 secured between the roller mount members 178 and the downwardly extending perimeter walls 152 of the platform member 124, as shown in FIG. 11, where the platform member 124 is inverted. Each pin or axle 176 supports a single roller member 172, although a common pin or axle 176 may be used for roller members 172 at the end of the plate member 124. Each pin or axle 176 is mounted with at least one end secured to a sidewall 152 of the platform 124. This configuration of the roller members 172 provides for facile on and off movement of articles from the ends of the weighing scale units 115 opposite the open end 127 of the sheath-like cavity 126 that receives the fork tine.

The slot apertures 170 and roller members 172 are distributed around the periphery of the contact surface 150 so as to avoid the areas occupied by each load cell 134 and by the summing box 138, as well as the sheath-like cavity 126 that accepts the tine. The roller members 172 allow smooth transfer of articles on and off of the time-mounted scale units 115 of the scale apparatus 110.

The embodiment of the tine mounted weighing scale apparatus having roller members 172 rotatably secured in slot apertures 170 of the flat, top contact surface 150 is particularly useful in the loading of cargo articles onto aircraft. Fork lifts and pallet trucks are not used within aircraft to exclude possible punctures to the aircraft exterior. Cargo is usually loaded into the aircraft cargo bay via sliding up an inclined ramp having many surface mounted rollers. The tine mounted weighing scale apparatus 110, having roller members 172 secured to the platform members 24, provides facile movement of cargo articles off of the tine mounted scale units 115 and onto the inclined ramp having rollers. Such a device is unique to the aircraft cargo industry, finding numerous applications in both the government (military) and private sectors.

Although the scale embodiments having one and two units have been described, the teachings of this invention are applicable to scales having three or more units.

The descriptions above and the accompanying drawings should be interpreted in the illustrative and not the limited sense. While the invention has been disclosed in connection with an embodiment or embodiments thereof, it should be understood that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A weighing scale comprising:
(a) a base mountable on a tine of a lifting device, the base having a predetermined number of load cell mounts, each one of the load cell mounts providing a deflection gap between the load cell and the base;
(b) a platform for contact with a load, the platform being disposed above and in operational contact with the base;
(c) a number of load cells equal to the number of load cell mounts, each one of the load cells being attached to one of the load cell mounts of the base and being positioned between the base and the platform; and
(d) a number of engagement members equal to the number of load cells, each one of the engagement members being in operational contact with the platform and one of the load cells.

2. The weighing scale of claim 1, wherein each one of the load cell mounts has at least one support position upon which one of the load cells is attached.

3. The weighing scale of claim 1, wherein the base includes a sheath cavity adapted for receiving a tine of a lifting device.

4. The weighing scale of claim 3, further including a fastener for securing the sheath cavity-containing base of the weighing scale to the tine of the lifting device.

5. The weighing scale of claim 1, further including an electrical control/display and a power supply, the electrical control/display in communication and remote from the weighing scale, the power supply being located in the electrical control/display.

6. The weighing scale of claim 1, further including a summing box for summing output from the predetermined number of load cells.

7. The weighting scale of claim 6 wherein the summing box is in communication with an electrical control/display.

8. The weighing scale of claim 1 wherein the predetermined number of load cells mounts, load cells and engagement members is at least four.

9. The weighing scale of claim 1 wherein the predetermined number of load cell mounts, load cells and engagement members is four with each load cell secured adjacent a corner of the base.

10. The weighing scale of claim 1, further including a plurality of rollers mounted in apertures atop the platform, the rollers adapted for transferring articles on and off the weighing scale.

11. The weighing scale of claim 10 wherein the rollers are rotatably mounted with their rotational axes in parallel.

12. The weighing scale of claim 10 wherein the rollers are rotatably mounted on pins with at least one pins end secured to a sidewall of the platform.

13. The weighing scale of claim 10 wherein the roller apertures are exterior a sheath cavity of the base.

14. The weighing scale of claim 1 wherein the engaging members include a fork nut secured to a bottom surface of the platform, the fork nut having a threaded cavity therein, and a threaded fastener traversing the load cell and secured within the nut threaded cavity.

15. The weighing scale of claim 1 wherein the load cells include shear beam load cells having a deflection gap at one end.

16. A tine mounted weighing scale apparatus comprising;
(a) at least two weighing scale units, each unit mountable to one tine of a lifting device, each weighing scale unit including;
(i) a base mountable on a tine of a lifting device, the base having a predetermined number of load cell mounts, each one of the load cell mounts providing a deflection gap between the load cell and the base;
(ii) a platform for contact with a load, the platform being disposed above and in operational contact with the base;
(iii) a number of load cells equal to the number of load cell mounts, each one of the load cells being attached to one of the load cell mounts of the base and being positioned between the base and the platform;
(iv) a number of engagement members equal to the number of load cells, each one of the engagement members being in operational contact with the platform and one of the load cells; and
(b) an electrical control/display and a power supply operatively connected to the at least two weighing scale units for displaying the total weight supported by the scale apparatus.

17. The weighing scale apparatus of claim 16, wherein each one of the load cell mounts has at least one support position upon which one of the load cells is attached.

18. The weighing scale apparatus of claim 16, wherein each said base includes a sheath cavity adapted for receiving a tine of a lifting device.

19. The weighing scale apparatus of claim 18, further including a fastener for securing each sheath cavity-containing base of the weighing scale to one tine of the lifting device.

20. The weighing scale of claim 16, further including a summing box for each scale unit, the boxes summing output from the predetermined number of load cells of each scale unit.

21. The weighing scale of claim 20 wherein the summing boxes are in communication with the electrical control/display.

22. The weighing scale of claim 16 wherein the predetermined number of load cells mounts, load cells and engagement members is at least two.

23. The weighing scale of claim 16 wherein the predetermined number of load cell mounts, load cells and engagement members is four with each load cell secured adjacent a corner of the base.

24. The weighing scale apparatus of claim 16, wherein the at least two weighing scale units are operatively connected in series to the electrical control/display and the power supply, the power supply being located in the electrical control/display, and the electrical control/display being remote from the weighing scale units.

25. The weighing scale apparatus of claim 16, further including a plurality of rollers mounted in apertures atop the platform of each scale unit, the rollers adapted for transferring articles on and off the weighing scale apparatus.

26. The weighing scale of claim 25 wherein the rollers are rotatably mounted with their rotational axes in parallel.

27. The weighing scale of claim 25 wherein the rollers are rotatably mounted on pins with at least one pins end secured to a sidewall of the platform.

28. The weighing scale of claim 25 wherein the roller apertures are exterior a sheath cavity of the base.

29. The weighing scale of claim 16 wherein the engaging members include a fork nut secured to a bottom surface of the platform, the fork nut having a threaded cavity therein, and a threaded fastener traversing the load cell and secured within the nut threaded cavity.

30. The weighing scale of claim 16 wherein the load cells include shear beam load cells having a deflection gap at one end.

31. A tine mounted weighing scale apparatus comprising;
(a) a pair of weighing scale units, each unit mountable to one tine of a lifting device, each weighing scale unit including;
(i) base mountable on a tine of a lifting device, the base having a predetermined number of load cell mounts, each one of the load cell mounts providing a deflection gap between the load cell and the base, the base including a sheath adapted for receiving a tine of a lifting device and a fastener for securing the sheath-containing base to the tine of the lifting device;
(ii) a platform for contact with a load, the platform being disposed above and in operational contact with the base;
(iii) a number of shear beam load cells equal to the number of load cell mounts, each one of the shear beam load cells being attached to one of the load cell mounts of the base and being positioned between the base and said platform;
(iv) a number of engagement members equal to the number of shear beam load cells, each one of the engagement members being in operational contact with the platform and one of the shear beam load cells, the engagement members including a fork nut secured to a bottom surface of the platform, the fork nut having a threaded cavity therein, and a threaded fastener traversing the load cell and secured within the nut threaded cavity;
(v) a summing box for summing output from the predetermined number of shear beam load cells; and
(b) an electrical control/display and a power supply operatively connected in series to the pair of weighing scale units for displaying the total weight supported by the scale apparatus.

32. The weighing scale of claim 31 wherein the predetermined number of load cells mounts, load cells and engagement members is at least four.

33. The weighing scale of claim 31 wherein the predetermined number of load cell mounts, load cells and engagement members is four with each load cell secured adjacent a corner of the base.

34. The weighing scale apparatus of claim 31, further including a plurality of rollers mounted in apertures atop the platform of each scale unit, the rollers adapted for transferring articles on and off the weighing scale apparatus.

35. The weighing scale of claim 34 wherein the rollers are rotatably mounted with their rotational axes in parallel.

36. The weighing scale of claim 34 wherein the rollers are rotatably mounted on pins with at least one pins end secured to a sidewall of the platform.

37. The weighing scale of claim 34 wherein the roller apertures are exterior a sheath cavity of the base.

38. A method of weighing an article with a lifting device comprising the steps of:
(A) providing a tine mounted weighing scale apparatus comprising;
(i) a pair of weighing scale units, each unit mountable to one tine of a lifting device, each weighing scale unit including;
(a) a base mountable on a tine of a lifting device, the base having a predetermined number of load cell mounts, each one of the load cell mounts providing a deflection gap between the load cell and the base;
(b) a platform for contact with a load, the platform being disposed above and in operational contact with the base;
(c) a number of load cells equal to the number of load cell mounts, each one of the load cells being attached to one of the load cell mounts of the base and being positioned between the base and the platform;
(d) a number of engagement members equal to the number of load cells, each one of the engagement members being in operational contact with the platform and one of the load cells; and
(ii) an electrical control/display and a power supply operatively connected to the pair of weighing scale units for displaying the total weight supported by the scale apparatus;
(B) securing each scale unit of the weighing scale apparatus to the tine of a lifting device;
(C) elevating the article off a support surface using the lifting device fitted with the scale apparatus; and
(D) observing the output of the electrical display.
